(19) United States
(12) Patent Application Publication
(10) Pub. No.: US 2025/0318014 A1
(43) Pub. Date: Oct. 9, 2025

(54) ROBUST EMERGENCY CALL METHOD AND CONTROLLER FOR A VEHICLE, AND COORDINATION CENTER

(71) Applicant: AUDI AG, Ingolstadt (DE)

(72) Inventors: Thorsten HEHN, Ingolstadt (DE); Oleg DIETRICH, Nürnberg (DE); Christoph RABHANSL, Ingolstadt (DE)

(73) Assignee: AUDI AG, Ingolstadt (DE)

(21) Appl. No.: 18/866,405

(22) PCT Filed: May 9, 2023
(86) PCT No.: PCT/EP2023/062284

§ 371 Date: Nov. 15, 2024

(30) Foreign Application Priority Data
May 20, 2022 (DE) 10 2022 112 676.5

(51) Int. Cl. H04W 76/50; H04M 1/72421; H04W 4/14; H04W 4/40; H04W 76/15

(52) U.S. Cl. CPC H04W 76/50; H04M 1/72421; H04W 4/14; H04W 4/40; H04W 76/15

(57) ABSTRACT

Method of sending an emergency call from a vehicle, in which, after an accident, a controller of the vehicle automatically establishes a connection to a coordination center. The controller of the vehicle sends an emergency call via the connection, so that the coordination center receives the emergency call from the controller of the vehicle.

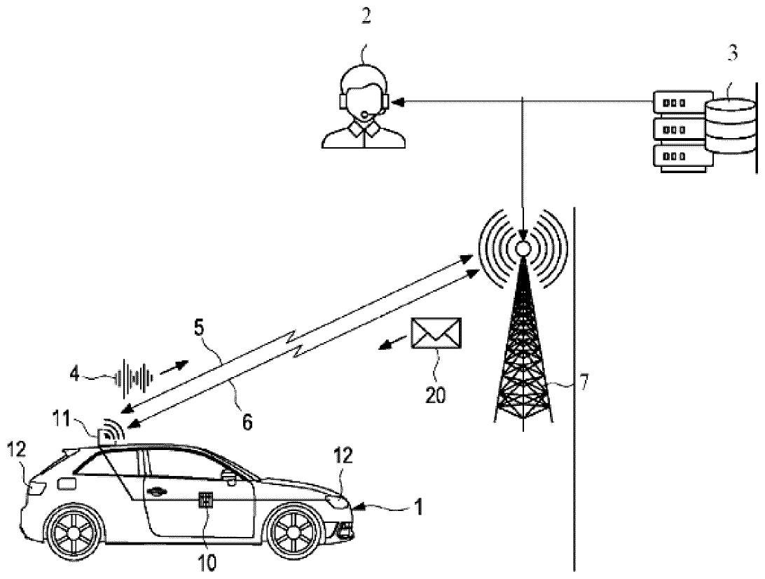

### CROSS-REFERENCE TO RELATED APPLICATIONS

This application is a U.S. national stage of International Application No. PCT/EP2023/062284, filed on May 9, 2023, which claims the priority benefit of German Patent Application No. 10 2022 112 676.5 filed on May 20, 2022. Both the International Application and the German Patent Application are incorporated by reference herein in their entirety.

### BACKGROUND

### 1. Field

Described examples of the invention may relate to a method for making an emergency call from a vehicle, in which, after an accident, a controller of a vehicle automatically establishes a first connection to a coordination center and makes an emergency call via the first connection established. The examples may further relate to a controller for a vehicle and to a coordination center for receiving an emergency call from a vehicle.

### 2. Description of the Related Art

Methods of the type mentioned at the outset for making an emergency call from a vehicle, emergency call methods for short, belong in different configurations in the prior art and are used, by way of the emergency call sent, to request appropriate assistance from a coordination center.

If a driver of a vehicle has entered into a contract with a service provider (Third Party Service Provider, TPSP), for example a manufacturer of the vehicle, to provide assistance after an accident, the vehicle is supposed to make the emergency call, if possible, to a private coordination center provided by the service provider, i.e. a contract coordination center.

For this purpose, DE 11 2011 101 204 B4 discloses a method for making an emergency call from a vehicle, in which the vehicle makes the emergency call to a contract coordination center if a contract coordination center corresponding to a country code sent by a mobile radio network exists, or to a non-contract coordination center if a non-contract coordination center corresponding to the sent country code exists.

A probability of the emergency call made bringing about the required suitable assistance is referred to here as a probability of success of the emergency call made or as a robustness of the respective emergency call method. A robust emergency call method has a high probability of success of the emergency call made.

A necessary prerequisite for making the emergency call is the connection to the coordination center. Accordingly, emergency call methods which establish the connection to the coordination center with a higher probability are more robust.

Thus, DE 11 2018 000 928 T5 discloses a method for making an emergency call from a vehicle, in which the vehicle establishes a second connection to a coordination center when establishment of a first connection to the coordination center has been unsuccessful.

A similar method for making an emergency call from a vehicle is described by U.S. Pat. No. 7,991,381 B1. The vehicle establishes a first voice connection to a coordination center. When the establishment of the first voice connection is unsuccessful, the vehicle establishes a second voice connection to the coordination center. When the establishment of the second voice connection is also unsuccessful, the vehicle finally establishes a data connection to the coordination center.

The robustness of the emergency call method may be affected by a plurality of error sources. For example, a malfunction of a communication unit of the vehicle, a malfunction of the coordination center or a misbehavior of an occupant of the vehicle can reduce the robustness of the emergency call method.

### SUMMARY

According to the described example, a method for making an emergency call from a vehicle may be provided, which has great robustness. In an example, a controller may be provided for a vehicle and a coordination center for receiving an emergency call from a vehicle.

The described examples of the invention may relate to a method for making an emergency call from a vehicle, in which, after an accident, a controller of a vehicle automatically establishes a first connection to a coordination center and makes an emergency call via the established connection. The emergency call method is used to automatically make an emergency call. An accident should generally be understood as meaning an emergency which should be understood as meaning the vehicle, an occupant of the vehicle and/or an event that needs help and is observed by an occupant of the vehicle in an environment of the vehicle. The automatic establishment of the first connection is triggered by a sensor signal provided by the vehicle or by actuation of an operating element by an occupant of the vehicle.

According to an example, the coordination center receives the emergency call sent and sends a message indicating a failure of the received emergency call to the controller if the emergency call is unsuccessful, and the controller receives the sent message and, after ending the first connection, automatically establishes a second connection to the coordination center that is separate from the first connection. In an example, the method and system may include receiving, by the coordination center server, the emergency call and sending a message indicating a failure of the received emergency call to the controller, if the emergency call is not successfully received by an agent of the coordination center server. The message indicating the failure of the received emergency call informs the controller of the failure of the emergency call and allows the controller to send the emergency call again via the second connection. A failure of the emergency call can result from an information technology (IT) problem or a temporary overload of the coordination center. Thanks to the second connection, a probability of success of the emergency call is increased.

The coordination center can send the message indicating the failure of the emergency call to the controller before ending the first connection or after ending the first connection. After receiving the emergency call, an agent at the coordination center can trigger the sending of the message if the coordination center cannot provide appropriate assistance.

In an example, the coordination center sends the message indicating the failure of the emergency call to the controller as an SMS message. The Short Message Service (SMS) supports the sending or receiving of short texts via a mobile radio network. A text of the SMS message indicates the failure of the emergency call. The controller is configured to receive the SMS message and to interpret the text of the SMS message.

In a further example, the first connection is established as a digital Voice over Internet Protocol (VoIP) connection, and the coordination center sends the message indicating the failure of the emergency call to the controller as a VoIP reply code before ending the first connection. The VoIP connection is a digital voice connection that transmits a digital audio stream of a conversation. The controller is configured to receive and interpret the VoIP reply code. The digital VoIP connection requires an IP capability of a mobile radio network.

In another example, the first connection is established as an analog voice connection, and the coordination center sends the message indicating the failure of the emergency call to the controller as an in-band command before ending the first connection. The in-band command is an auditively imperceptible analog signal that overlies the analog audio stream. The controller is configured to receive and interpret the in-band command. The in-band command requires a client-server (CS) capability of a fixed line network.

The coordination center can forward the received emergency call to a backend server. In this case, the coordination center acts as an intermediary. An operator of the backend server can provide special assistance. This further increases the robustness of the emergency call method. For example, the backend server is provided by a manufacturer of the vehicle.

In an example, the emergency call may be made simultaneously via a data channel of the first connection that differs from a voice channel. The data channel enables the emergency call to be made even if occupants of the vehicle are prevented from speaking to the coordination center, for example due to a loss of consciousness or an injury or due to a triggered restraining system such as an airbag. This further increases a robustness of the emergency call method. Alternatively, the data channel can belong to a connection parallel to the first connection and can connect the vehicle directly to the backend server.

A legal coordination center or a private coordination center can participate in the method as the coordination center. The legal coordination center (Public Safety Answering Point, PSAP) may be officially provided. The private coordination center may be provided by a private operator (Third Party Service Provider, TPSP).

In this way, two permissible types of coordination centers may be supported, thus further increasing a robustness of the emergency call method.

The described examples of the invention may also relate to a controller for a vehicle for making an emergency call. The controller may be installed in a multiplicity of vehicles and can be configured as a controller according to the described examples by updating software of the controller.

According to an example, the controller may be configured to participate in a method according to the described examples to send an emergency call. The controller enables great robustness of the emergency call method and great safety of the vehicle.

The described examples of the invention may also relate to a coordination center for receiving an emergency call sent from a vehicle. The coordination center can be configured as a coordination center according to the described examples by updating software.

According to an example, the coordination center may be configured to participate in a method according to the described examples. The coordination center enables great robustness of the emergency call method and great safety of the vehicle.

Furthermore, the robustness of the emergency call method can be increased by automatically resetting and/or automatically restarting the controller and/or a communication unit of the vehicle after a repeated unsuccessful attempt to establish the first connection to a private coordination center and/or a legal coordination center. After being reset and/or restarted, the controller can try to establish the first connection to the private coordination center and/or the legal coordination center again several times.

In this way, a malfunction of the communication unit based on a runtime error, i.e. a dynamic malfunction, for example as a result of an unfavorable mobile radio configuration of the communication unit, and/or a malfunction of the controller or the communication unit caused by firmware of the controller or the communication unit, which cannot be rectified or can be rectified with difficulty by a manufacturer (Original Equipment Manufacturer, OEM) of the controller or the communication unit, can each be ended, which is associated with great robustness of the emergency call method.

Another possible way of increasing the robustness of the emergency call method is for the coordination center to receive the emergency call sent from the vehicle only if the emergency call sent is received by an agent of the coordination center. This prevents a telephone system of the coordination center from receiving the sent emergency call without an agent of the coordination center providing suitable assistance, which is associated with great robustness of the emergency call method.

Apart from this, the robustness of the emergency call method can be increased by virtue of the controller controlling a light of the vehicle that is visually perceptible from an environment of the vehicle in order to alert an occupant of the vehicle arranged in the environment of the vehicle to an established connection to a coordination center. This prevents a possible emergency call from not being made because the occupant has left the vehicle after the accident. The occupant can return to the vehicle and make the emergency call, which is associated with great robustness of the emergency call method.

### BRIEF DESCRIPTION OF THE DRAWINGS

The described examples are schematically illustrated in the drawings and are described further with reference to the drawings, in which:

A figure shows a functional block diagram of a controller according to an example for a vehicle.

### DESCRIPTION

The Figure shows a functional block diagram of a controller 10 according to an example for a vehicle 1, which controller belongs to the vehicle 1 and may be suitable for sending an emergency call 4. The controller 10 may be implemented be a computer processor functioning as a client in a client-server model. The vehicle 1 further comprises a communication unit 11 which is configured to establish, via a mobile radio network 7, first and second connections 5, 6 to a coordination center 2 (a computer server 2) or to a backend server 3 (backend computer server 3). The coordination center 2 may be suitable for receiving an emergency call 4 sent from the vehicle 1. In an example, the coordination center 2 and the backend server 3, may be respectively implemented by at least one computer processor functioning as a server.

The controller 10 and the coordination center 2 may each be configured to participate in a method according to the described examples for sending an emergency call 4.

After an accident, the controller 10 of the vehicle 1 automatically establishes a first connection 5 to the coordination center 2 and sends an emergency call 4 via the first connection 5 established. The controller 10 can establish the first connect ion 5 as a digital VoIP connection or as an analog voice connection. For example, a legal coordination center (PSAP) or a private coordination center (TPSP) participates in the method as the coordination center 2. The controller 10 advantageously controls a light 12 of the vehicle 1 that is visually perceptible from an environment of the vehicle 1.

After a repeated unsuccessful attempt to establish the first connection 5 to a private coordination center and/or a legal coordination center, the controller 10 and/or the communication unit 11 of the vehicle 1 is expediently automatically reset and/or automatically restarted. After being reset and/or restarted, the controller 10 can attempt to establish the first connection 5 to the private coordination center and/or the legal coordination center again several times.

The coordination center 2 receives the emergency call 4 sent and sends a message 20 indicating a failure of the received emergency call 4 to the controller 10, if the emergency call 4 is unsuccessful (i.e., the emergency call is not successfully received by an agent of the coordination center server 2). The coordination center 2 advantageously forwards the received emergency call 4 to the backend server 3.

The coordination center 2 may receive the emergency call 4 sent from the vehicle 1 only if the emergency call 4 is received by an agent of the coordination center 2.

The coordination center 2 can send the message 20 indicating the failure of the emergency call 4 to the controller 10 before ending the first connection 5 or after ending the first connection 5.

In particular, the coordination center 2 can send the message 20 indicating the failure of the emergency call 4 to the controller 10 as an SMS message.

If the controller 10 has established the first connection 5 as a digital VoIP connection, the coordination center 2 can send the message 20 indicating the failure of the emergency call 4 to the controller 10 as a VoIP reply code before ending the first connection 5. If the controller 10 has established the first connection 5 as an analog voice connection, the coordination center 2 can send the message 20 indicating the failure of the emergency call 4 to the controller 10 as an in-band command before ending the first connection 5.

The controller 10 receives the sent message 20 and, after an end of the first connection 5, automatically establishes a second connection 6 to the coordination center 2 that is separate from the first connection 5.

The emergency call 4 can be sent simultaneously via a data channel of the first connection 5 that differs from a voice channel, in particular directly to the backend server 3.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS:

Vehicle
10 Controller
11 Communication unit
12 Light
2 Coordination center
20 Message
3 Backend server
4 Emergency call
5 First connection
6 Second connection
7 Mobile radio network

1-10. (canceled)

11. A method of sending an emergency call from a vehicle, comprising:
by a controller of the vehicle,
automatically establishing a first connection to a coordination center server, after an accident involving the vehicle, and
sending an emergency call via the first connection to the coordination center server;
receiving, by the coordination center server, the emergency call and sending a message indicating a failure of the received emergency call to the controller, if the emergency call is not successfully received by an agent of the coordination center server; and
receiving, by the controller the message and, after an end of the first connection, automatically establishing a second connection to the coordination center server that is separate from the first connection.

12. The method as claimed in claim 11, in which the coordination center server sends the message indicating the failure of the emergency call to the controller before ending the first connection or after ending the first connection.

13. The method as claimed in claim 12, in which the coordination center server sends the message indicating the failure of the emergency call to the controller as an SMS message.

14. The method as claimed in claim 11, in which the first connection is established as a digital VoIP connection, and the coordination center server sends the message indicating the failure of the emergency call to the controller as a VoIP reply code before ending the first connection.

15. The method as claimed in claim 11, in which the first connection is established as an analog voice connection, and the coordination center server sends the message indicating the failure of the emergency call to the controller as an in-band command before ending the first connection.

16. The method as claimed in claim 11, in which the coordination center server forwards the received emergency call to a backend server.

17. The method as claimed in claim 11, in which the emergency call is simultaneously sent via a data channel of the first connection that differs from a voice channel of the first connection.

18. The method as claimed in claim 11, in which a legal coordination center server or a private coordination center server serves as the coordination center server.

19. A controller for a vehicle, comprising:
a computer processor configured to execute a process including, automatically establishing a first connection to a coordination center server, after an accident involving the vehicle;
sending an emergency call via the first connection to the coordination center server;
receiving a message from the coordination center server indicating a failure of the emergency call, if the emergency call is not successfully received by an agent of the coordination center server; and
receiving the message and, after an end of the first connection, automatically establishing a second connection to the coordination center server that is separate from the first connection.

20. A coordination center server, comprising:
a computer processor configured to execute a process including,
establishing a first connection to a controller of a vehicle, after an accident involving the vehicle;
receiving an emergency call via the first connection;
sending a message indicating a failure of the emergency call, if the emergency call is not successfully received by an agent of the coordination center server; and
establishing a second connection to the controller that is separate from the first connection.

21. The controller as claimed in claim 19, in which the coordination center server sends the message indicating the failure of the emergency call to the controller before ending the first connection or after ending the first connection.

22. The controller as claimed in claim 19, in which the coordination center server sends the message indicating the failure of the emergency call to the controller as an SMS message.

23. The controller as claimed in claim 19, in which the first connection is established as a digital VoIP connection, and the coordination center server sends the message indicating the failure of the emergency call to the controller as a VoIP reply code before ending the first connection.

24. The controller as claimed in claim 19, in which the first connection is established as an analog voice connection, and the coordination center server sends the message indicating the failure of the emergency call to the controller as an in-band command before ending the first connection.

25. The controller as claimed in claim 19, in which the coordination center server forwards the received emergency call to a backend server.

26. The controller as claimed in claim 19, in which the emergency call is simultaneously sent via a data channel of the first connection that differs from a voice channel.

27. The controller as claimed in claim 19, in which a legal coordination center server or a private coordination center server participates as the coordination center server.
